(19) United States
(12) Patent Application Publication
(10) Pub. No.: US 2011/0067301 A1
(43) Pub. Date: Mar. 24, 2011

(54) Vertical Hydroponics System

(76) Inventors: Mark DeMitchell, San Marcos, CA (US); Michael Tarzian, Carlsbad, CA (US)

(21) Appl. No.: 12/871,060

(22) Filed: Aug. 30, 2010

Related U.S. Application Data
(60) Provisional application No. 61/244,204, filed on Sep. 21, 2009.

(51) Int. Cl. A01G 31/02; F16K 27/00

(52) U.S. Cl. 47/62 C; 251/356

(57) ABSTRACT

A hydroponic system useful for providing a continuous flow nutrient solution to the roots of a plurality of plants. The system includes a tubular assembly of horizontally inclined members interconnected to each other at elbow joints, and comprising a plurality of cutouts configured to receive the roots of the plurality of plants, and having a top entry and a bottom exit. A pump is configured to pump the nutrient solution to the top entry of the tubular assembly, wherein the angles of the horizontally inclined members allow the solution to flow downward through the tubular assembly before exiting through the bottom to return to the pump.

### 1.0 BACKGROUND

The two chief merits of the hydroponics are, first, much higher crop yields, and second, the fact that hydroponics can be used in places where ordinary agriculture or gardening is impossible. People living in crowded city streets, without gardens, can grow fresh vegetables and fruits in window-boxes or on house tops. By means of hydroponics all such places can be made to yield a regular and abundant supply of clean, health-giving greens. Other advantages include faster growth combined with relative freedom from soil diseases, and very consistent crops, the quality of produce being excellent. There is also a considerable reduction in growing area, weeds are practically non-existent, while automatic operation results in less labor, cost, and maintenance.

There are primarily two types of hydroponics systems: static solution culture and continuous flow solution culture. In static solution culture, plants are grown in containers of nutrient solution. The nutrient solution is either changed on a schedule, such as once per week, or when the concentration drops below a certain level. Whenever the solution is depleted below a certain level, either water or fresh nutrient solution is added to make the necessary adjustment.

In continuous flow solution culture the nutrient solution constantly flows past the roots. A variation is the nutrient film technique or NFT whereby a very shallow stream of water containing all the dissolved nutrients required for plant growth is recirculated past the bare roots of plants in a watertight gully, also known as channels. Ideally, the depth of the recirculating stream should be very shallow, little more than a film of water, hence the name “nutrient film”. This ensures that the thick root mat, which develops in the bottom of the channel, has an upper surface which, although moist, is in the air. An advantage of the NFT system over other forms of hydroponics is that the plant roots are exposed to adequate supplies of water, oxygen and nutrients. While slopes along channels of 1:100 have been recommended, in practice it is difficult to build a base for channels that is sufficiently true to enable nutrient films to flow without ponding in locally depressed areas. Consequently, it is recommended that steeper slopes be used. This allows for minor irregularities in the surface but, even with these slopes, ponding and waterlogging may occur.

The structure of hydroponics systems can be broken down into horizontal systems and vertical systems. Horizontal systems are more common and generally feature a tray into which the nutrient rich solution is introduced. These systems generally rely on a static solution culture with the plant roots immersed into the solution. A drawback to the static solution culture is that the roots may not be exposed to sufficient oxygen which may reduce the plaint yield. Also, horizontal systems required a large footprint, such that they are not efficient where space is a premium such as in populated areas.

Vertical systems address the problems associated with the small footprint by allowing several plants to grow along the same vertical access. In other words, the plant growth areas are not limited to the two dimensional restraints of the horizontal systems; rather the vertical systems take advantage of the vertical direction to increase the plant density. Some vertical systems are simple several horizontal systems stacked on top of each other. For example is FIG. 7, the system 500 comprises four horizontal elements 505 with the nutrient rich solution included within these elements as a static solution culture. The plants are installed in the holes (410) included in each of the horizontal elements (505). In FIG. 8, another prior art vertical hydroponics system (600) is shown, which has several cups (605) to receive plants. This system uses a continuous flow culture, but not a NFT so the roots may not be exposed to a constant supply of nutrient, water and oxygen, thus lowering plant yield. Also the system in FIG. 6 is a proprietary design such that maintenance costs of the system including replacement part, would be expensive, as would manufacturing costs. Finally, at FIG. 9 the popular Vertigro® system (700) (www.vertigro.com) is shown with several pots (705) that receive plants. But again this system is not NFT such that the plants may not experience the most efficient administration of nutrients, water and oxygen. And again this system uses a proprietary design, further increasing the costs of operation.

What is therefore needed is a vertical hydroponics system that implements NFT and can accommodate several plants. The system should avoid the drawbacks of ponding and waterlogging plaguing previous NFT hydroponics systems and ideally the system may be constructed of non-proprietary parts, such that maintenance and manufacturing costs can be minimized.

### 2.0 SUMMARY OF THE INVENTION

The teachings herein are directed to a hydroponic system for providing a continuous flow nutrient solution to the roots of a plurality of plants, comprising: (a) a tubular assembly of horizontally inclined members interconnected to each other at elbow joints, and comprising a plurality of cutouts configured to receive the roots of the plurality of plants, and having a top entry and a bottom exit, (b) a support structure configured to couple to and support the tubular assembly, and (c) a pump operably coupled to the top entry and the bottom exit of the tubular assembly, and configured to pump the nutrient solution to the top entry of the tubular assembly, wherein the angles of the horizontally inclined members allow the solution to flow downward through the tubular assembly while contacting the roots before exiting through the bottom to return to the pump.

### 3.0 DESCRIPTION OF THE DRAWINGS

FIG. 1A illustrates a novel vertical hydroponics system.

FIG. 1B illustrates a novel vertical hydroponics system.

FIG. 2 illustrates the novel vertical hydroponics system of FIG. 1A from the front of the system.

FIG. 3 illustrates the novel vertical hydroponics system of FIG. 1A from the side of the system.

FIG. 4 illustrates the novel vertical hydroponics system of FIG. 1B from the front of the system.

FIG. 5 illustrates the novel vertical hydroponics system of FIG. 1B from the side of the system.

FIGS. 6a and 6b illustrate a serpentine embodiment of the novel vertical hydroponics system.

FIG. 7 illustrates a prior art vertical hydroponics system.

FIG. 8 illustrates a prior art vertical hydroponics system.

FIG. 9 illustrates a prior art vertical hydroponics system.

### 4.0 DETAILED DESCRIPTION

This disclosure involves a new vertical hydroponics system that implements a very efficient NFT to increase the plant yield over previous vertical system. Also, the system is constructed of very common materials that can be purchased at your local hardware store, thus reducing the costs for maintenance and construction.

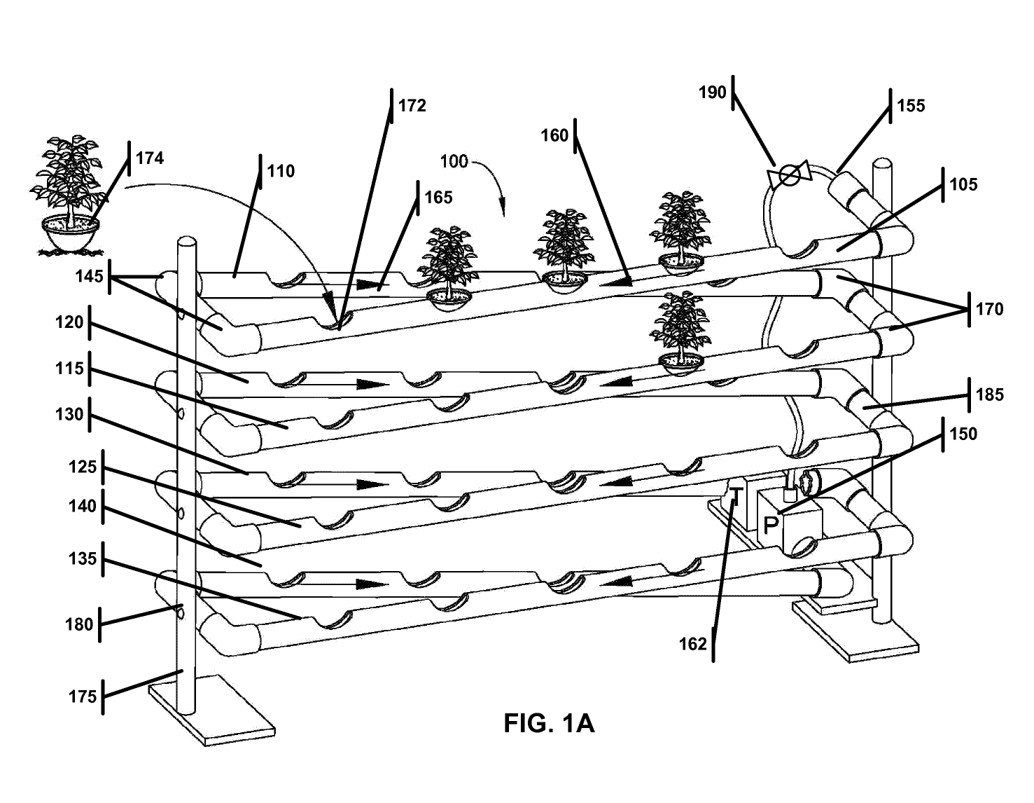

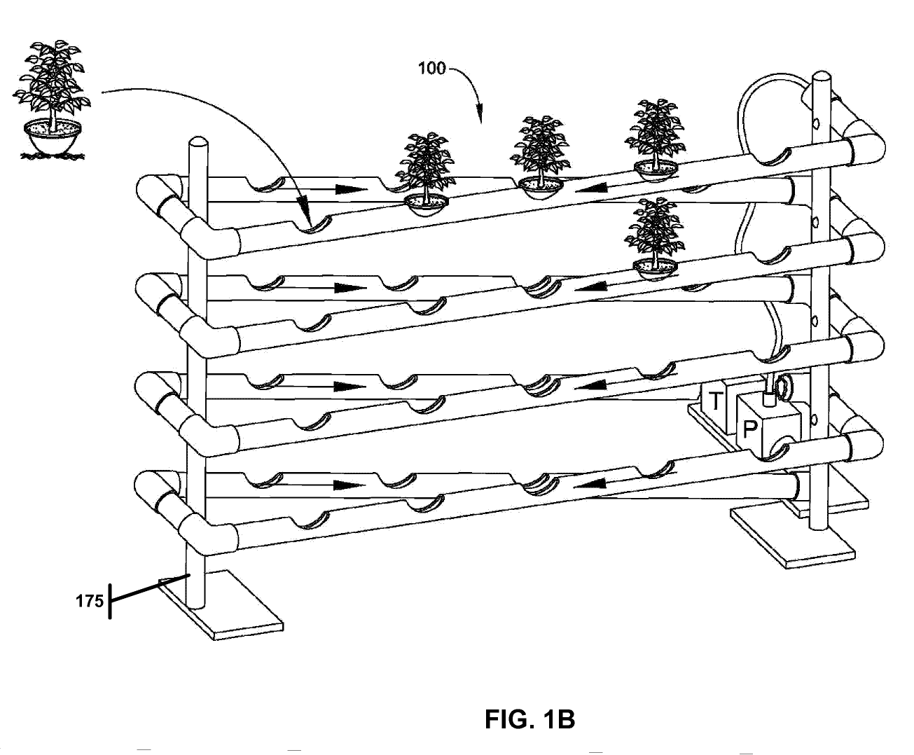

FIG. 1A illustrates the novel vertical hydroponics system (100). The system may be constructed of a PVC tube of approximately 4 inches in diameter along with several common elbow joints. While the elbow joints shown in FIG. 1A are 90° , the elbow joints could be of various angles. Finally, the system may also include a timer that controls a pump, which can deliver the nutrient rich solution to the plant. The embodiment shown in FIG. 1A, comprises eight inclined horizontal members (105, 110, 115, 120, 125, 130, 135, 140) comprised of PVC pipe connected to each other by a series of 90° elbows (e.g., 145). Nutrient rich solution is pumped from the pump (150) to position 155, and from there the nutrient rich solution travels down the inclined horizontal member (105) in the direction of arrow 160 via gravity using NFT. The series of 90° elbows (145) redirects the flow to the second inclined horizontal member (110) allowing the solution to continue to flow in the direction of arrow 165. The second inclined horizontal member (110) is connected to the third include horizontal member (115) by 90° elbows (170). This serpentine shape of the system continues until the solution arrives at the pump (150), and the solution is once again pumped to position 155 to complete the circuit. The pumping action may be controlled by the timer (162). The pump rate will depend on the plant variety and plant size. The pump (150) may optionally include a reservoir to store more nutrient solution; thus extending the time needed between maintenance visits. The system (100) may optionally include a valve (190) to regulate the nutrient flow and provide the needed flexibility to address any plant size or variety. While the system (100) has been described with a tube with a circular cross-section, it should be appreciated that other cross sectional shapes can be implemented and other diameters as well. It should also be appreciated that any number of different materials may be used instead of PVC. It would also be apparent that the pipe segment between the 90° elbows (145 and 170) could also be inclined and could also have a cutout(s) for even higher plant densities.

Included in the inclined horizontal members are cutouts adapted to receive a plant (172). The plant may be placed in a porous basket (174), and the basket (174) can be placed in the cutout (172). The basket (174) functions to fix the plant in the cutout (172) and preventing it from dislodging and entering the pumping system. The basket (174) is porous so as to allow the solution to come into contact with the plant roots. The basket (174) may be sufficiently porous to allow the plant roots to exit the basket (174), thus increasing the amount of roots that contact the solution.

Optionally, the tubular members of the system (100) may be adjustably connected to the support structure. Specifically, system (100) includes a support structure (175) to which the tubular elements of the system (100) are attached (see e.g., attachment 180). It should be appreciated that the support structure (175) may be placed on the inside of the serpentine pipes as shown in FIG. 1B. The support structure (175) may have multiple attachment sites such that the tubular members can be attached at a higher position or a lower position. And because the connection of the inclined horizontal members to the elbows need not be immobile, but rather a flexible slip fit, the system can easily be adjusted increase or decrease the inclination of the inclined horizontal members. This flexibility allows the user to customize the system to meet his or her specific needs because different plants thrive on different NFT flows. And by adjusting the inclination, the nutrient flows may be adjusted to optimize the system for the desired plant.

Depending on the length of the entire system (100), plants in the down stream position may experience a nutrient solution that has been depleted of certain nutrients. The results of this may be decreased growth of plants in the downstream position.

Therefore it might be desirable to introduce a second nutrient solution feed at a downstream position (e.g. position 185) to replenish the nutrient balance of the solution.

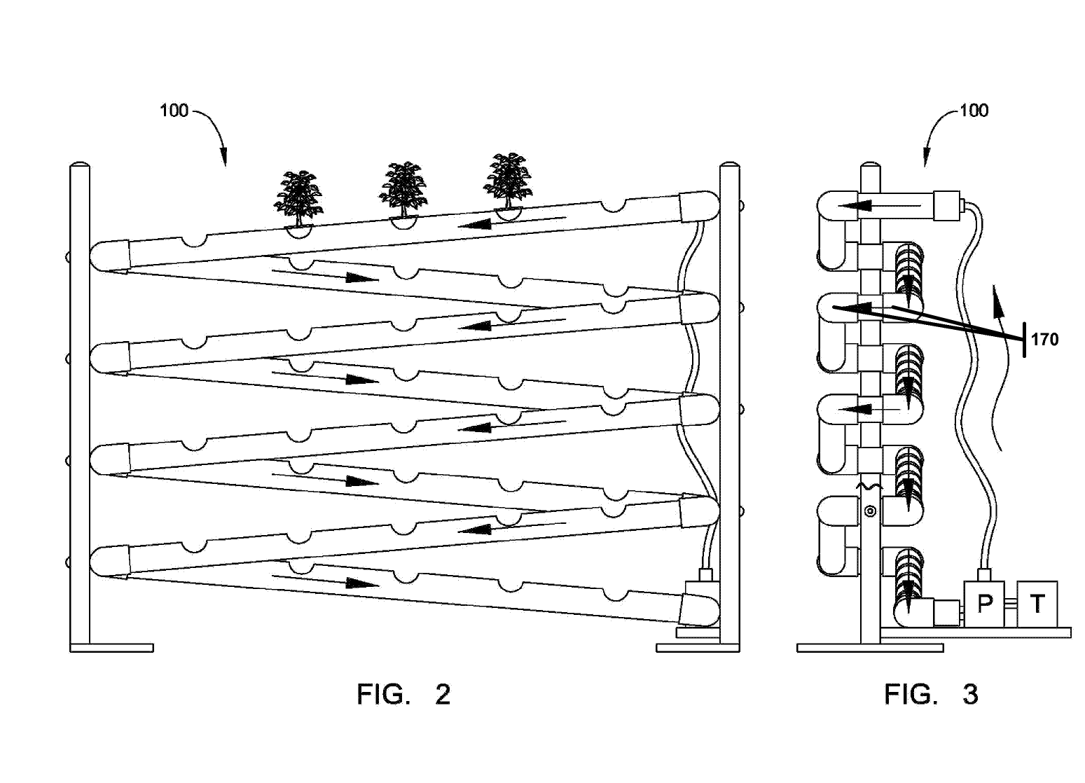

FIG. 2 shows a head on perspective of the vertical hydroponics system (100). From this perspective the incline of each horizontal inclined member can be more fully appreciated, as well as the flow of the solution through the system. FIG. 3 is a side perspective of the system (100)—i.e., head on with respect to the elbows (170). Once again, it should be appreciated that the tube in between the elbows may be lengthened and/or inclined, and may also include cutouts for plants to increase plant densities.

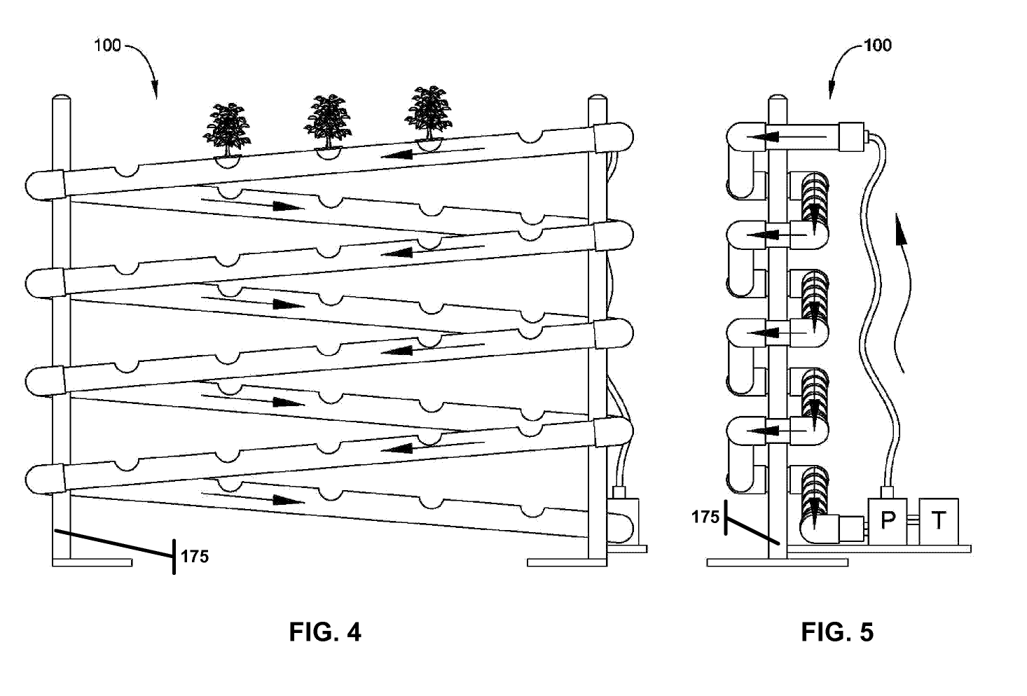

FIGS. 4 and 5 show the front and side view, respectively, of the embodiment presented in FIG. 1B. The main difference is that the support structure (175) is placed on the inside of the serpentine pipes.

Another benefit of the system (100) just described is that it may be formed of a smooth PVC pipe, such that the pipe will not include divots or other imperfections that would tend to cause ponding or waterlogging. Without these imperfections the slope of the inclined horizontal members need not be too extreme, and thus more inclined horizontal members may be used in a single system yielding a higher plant density.

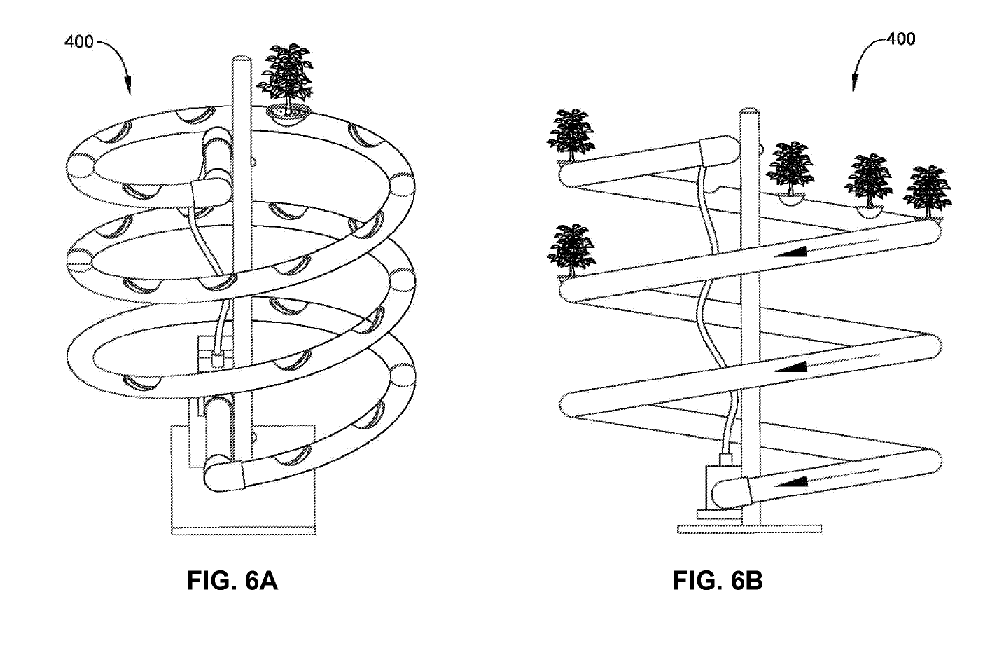

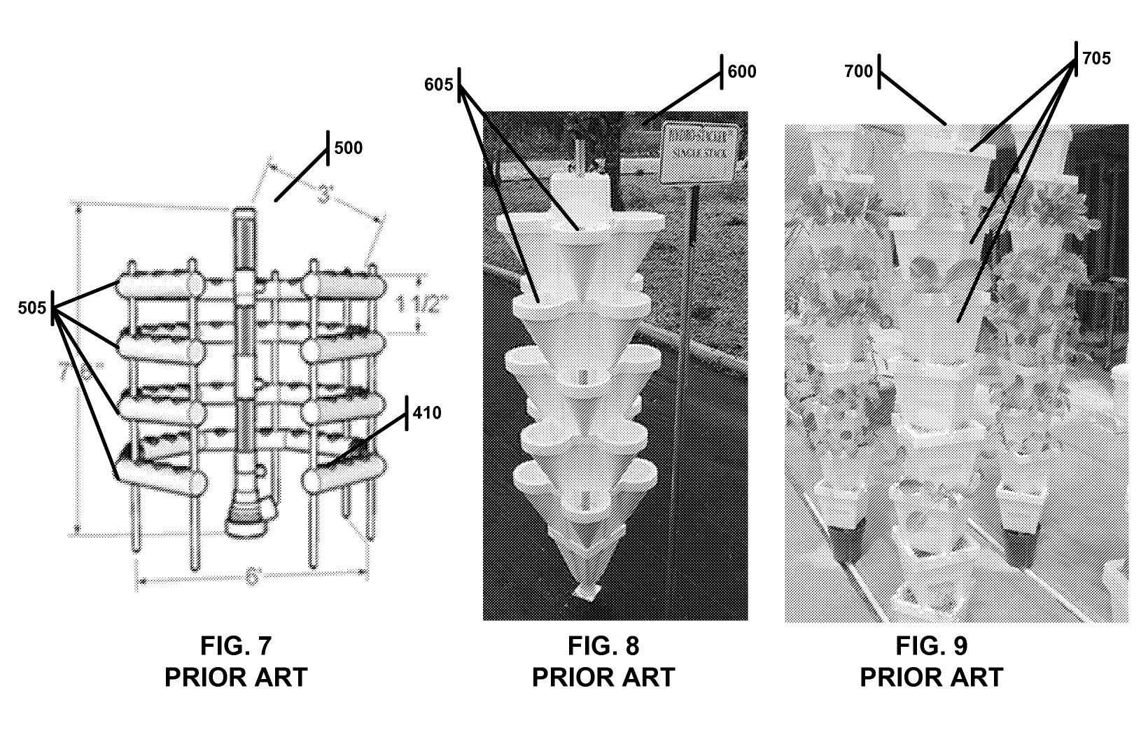

While the system (100) has been shown as a rectilinear structure, it would be apparent that the system may also be constructed as serpentine shaped with cutouts that are generally horizontal to the floor. This embodiment is shown in FIGS. 6a and 6b. This system (400) does not employ elbows. The system (400) may be a single continuous serpentine shape, or may be comprised of several segments. The benefit to having several serpentine segments is that the height of the system could be increased using more segments or reduced by using fewer. Also, should one of the segments become damaged, that segment can be easily replaced without the cost or hassle of replacing the entire system. A drawback to the serpentine shaped system is that it is not constructed of readily available parts such that maintenance and replacement costs may be higher. Another slight drawback is that serpentine shaped system yield essentially a circular foot print, thus placing the system (400) in everyday location—i.e., along a side yard wall—the system (400) would not lie flat against the wall resulting in an inefficient use of space. Similarly, placing serpentine shaped systems (400) in a rectangular greenhouse would yield an inefficient use of space.

While particular preferred and alternative embodiments of the present invention have been disclosed, it will be appreciated that many various modifications and extensions of the above described technology may be implemented using the teaching of this patent application. All such modifications and extensions are intended to be included within the true spirit and scope of this patent application.

1. A hydroponic system for providing a continuous flow nutrient solution to the roots of a plurality of plants, comprising:
a tubular assembly of horizontally inclined members interconnected to each other at elbow joints, and comprising a plurality of cutouts configured to receive the roots of the plurality of plants, and having a top entry and a bottom exit,
a support structure configured to couple to and support the tubular assembly, and
a pump operably coupled to the top entry and the bottom exit of the tubular assembly, and configured to pump the nutrient solution to the top entry of the tubular assembly, wherein the angles of the horizontally inclined members allow the solution to flow downward through the tubular assembly while contacting the roots before exiting through the bottom to return to the pump.

2. The hydroponic system of claim 1, wherein the horizontally inclined tubular members are constructed of polyvinyl chloride (PVC) piping.

3. The hydroponic system of claim 1, wherein the horizontally inclined tubular members are approximately 4 inches in diameter.

4. The hydroponic system of claim 1, wherein the pump is operably coupled to a timer to control the amount of nutrient solution being pumped.

5. The hydroponic system of claim 1, further comprising a valve positioned between the pump and the top entry of the tubular assembly and configured to regulate the flow of the nutrient solution.

6. The hydroponic system of claim 1, wherein the support structure comprises two parallel vertical standing PVC pipes.

7. The hydroponic system of claim 6, wherein the two parallel vertical standing PVC pipes are configured to adjustably couple to either the inside or outside of the tubular assembly.

8. The hydroponic system of claim 1, wherein the support structure comprises a plurality of different attachment sites for the tubular assembly to accommodate different sized and angled horizontally inclined elements.

9. The hydroponic system of claim 1, wherein the cutouts and the diameter of the horizontally inclined members are configured to allow the roots to be exposed only to a film of nutrient solution, such that the roots are also exposed to air within the horizontally inclined members.

10. The hydroponic system of claim 1, wherein the tubular assembly is serpentine shaped with elbows.

11. The hydroponic system of claim 10, wherein the tubular assembly comprises eight horizontally inclined members.

12. The hydroponic system of claim 11, wherein a nutrient feed is operably coupled to the tubular assembly between the top entry and the bottom exit.

13. The hydroponic system of claim 1, wherein the elbow joints are 90° elbow joints.

14. The hydroponic system of claim 1, wherein the elbow joints are 45° elbow joints.

15. The hydroponic system of claim 1, further comprising a reservoir coupled to the pump.

16. The hydroponic system of claim 1, further comprising a porous basket configured to receive one of the plurality of plants and configured to fit into one of the plurality of cutouts.

17. The hydroponic system of claim 16, wherein the basket is sufficiently porous to allow the roots from the plant to exit the basket.
